(19) United States
(12) Patent Application Publication
(10) Pub. No.: US 2008/0184160 A1
(43) Pub. Date: Jul. 31, 2008

(54) Method and computer system capable of presenting program graphics user interface on title bar window

(75) Inventors: Chia-Hao Chang, Taipei City (TW); Wen-Shiu Hsu, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 12/007,411

(22) Filed: Jan. 10, 2008

(30) Foreign Application Priority Data
Jan. 15, 2007 (TW) 096101469

(51) Int. Cl. G06F 3/048

(52) U.S. Cl. 715/781

(57) ABSTRACT

The invention relates to a method and computer system capable of presenting program graphics user interface on the title bar of a window. The method includes the following steps. First whether a new operating window is established is determined; if it is yes, whether the new operating window conforms to a predefined window type is determined; if it is yes, and the new operating window includes a title bar and a coordinate location relative to the desktop, a target location relative to the desktop is calculated according to the coordinate location of the operating window; then, a program graphics user interface window is established; the program graphics user interface is located at the target location on the desk, wherein the program graphics user interface window is an individual independent of the operating window.

### BACKGROUND OF THE INVENTION

1. Field of the Invention

The invention relates to the Windows operating system of a personal computer and, more particularly, to a method and computer system capable of presenting a program graphics user interface on a title bar of window.

2. Description of the Related Art

Nowadays, for a personal computer, the information is presented to the user on the window by executing Windows operating system to display the window. Many kinds of application software program executed by a computer system provide a user interface of a window presenting many kinds of information. As show in FIG. 1, a window 11 represents, for example, a defined area in a computer screen 12. The information provided by a program is presented in the area. Generally, the window 11 permits a program or an operating system to operate the window 11 or the content presented in the window 11 without influencing the information displayed out of the window.

For example, a user can change the location and the size of the window 11 displayed on a computer screen 12 via a mouse 13. The user also can use the icons, “maximize”, “minimize”, or “close”, to maximize, minimize, or close the window 11. The icons “maximize”, “minimize”, and “close”, which are usually denoted by “_”, “□”, and “X”, are displayed on the right end of the title bar 111 on the top edge of the window 11. Furthermore, the user can also use the scroll bar 112 on the right side of the window 11 to scroll the information in the window 11 without influencing the information displayed in other windows.

To better operate the window 11, an application program is used to provide an additional program graphics user interface window 15 to change the location and the size of the window 11 fast. As show in FIG. 1, when an application program is executed, the program graphics user interface window 15 is drawn in the title bar 111 of the window 11 to be a part of the window 11. Therefore, when the window 11 is moved, the program graphics user interface window 15 moves with it. The user can control the window 11 fast via the program graphics user interface window 15.

In a conventional operating system, other icons such as the program graphics user interface window 15 can be permitted to be drawn on the title bar 111 of the window 11, and. the program graphics user interface window 15 is integrated with the window 11.

However, considering the new certain generation operating system, the window may not be allowed to be changed, so the original application program can not draw the program graphics user interface window in the title bar of the window. Therefore, the function of quickly controlling the window can not be provided, which is a deficiency in window operation.

### BRIEF SUMMARY OF THE INVENTION

An objective of the invention is to provide a method and computer system capable of presenting program graphics user interface on the title bar of a window, and a function of presenting program graphics user interface window on the title bar of a window in the new generation Windows operating system to control window operation conveniently and fast.

According to a characteristic of the invention, a method capable of presenting program graphics user interface on the title bar of a window is provided. A Windows operating system is installed in the computer to provide a desktop on a screen of the computer. The method includes the steps of (A) determining whether a new operating window is established, (B) if the new operating window is established, determining whether the new operating window conforms to a predefined window type, (C) if the new operating window conforms to the predefined window type, and the operating window has a title bar and a coordinate location relative to the desktop, calculating a target location relative to the desktop according to the coordinate location of the operating window, (D) establishing a program graphics user interface window, (E) locating or pasting the program graphics user interface window at the target location on the desktop, wherein the program graphics user interface window is an individual independent of the operating window.

According to another characteristic of the invention, a computer system capable of presenting program graphics user interface on the title bar of a window is provided. It includes a pointer input device, a computer host for running a Windows operating system, and a screen unit on which the Windows operating system provides a desktop for using a pointer input device to operate by the pointer to establish an operating window which conforms to a type of a predefined window on the desktop, wherein the operating window includes a title bar having a target location relative to the desktop; a program graphics user interface window is established and located or posted on the desktop at a target location which is calculated according to the coordinate location of the operating window, and the program graphics user interface window is an individual independent of the operating window.

### BRIEF DESCRIPTION OF THE DRAWINGS

FIG. 1 is a schematic diagram showing the conventional operating system window on the computer screen.

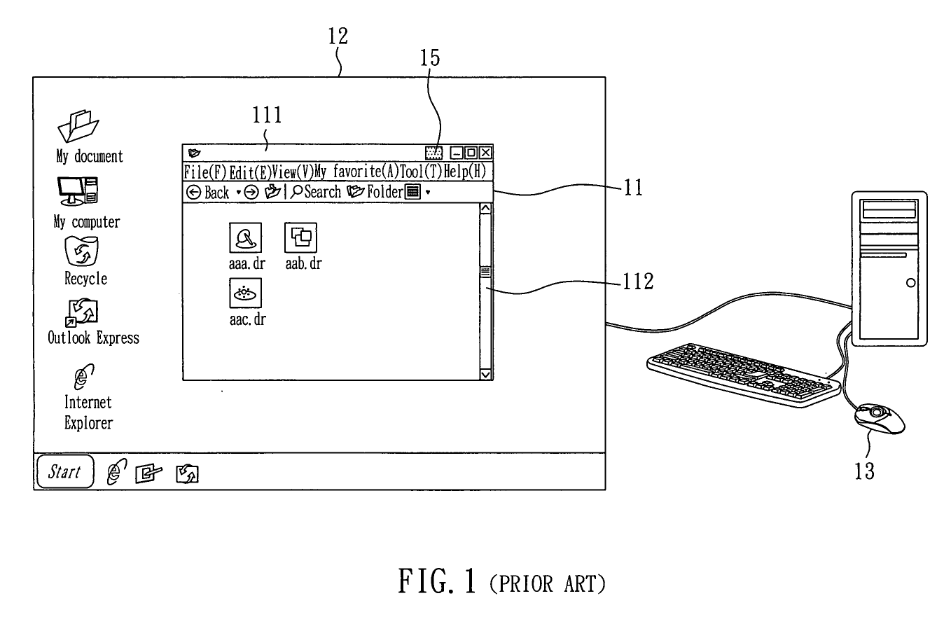

FIG. 2 is a schematic diagram showing the computer system capable of presenting a program graphics user interface on a title bar of a window of a preferred embodiment of the invention.

FIG. 3 is a control flowchart showing the method capable of presenting a program graphics user interface on a title bar of a window of a preferred embodiment of the invention.

FIG. 4 is a schematic diagram showing that the operating window and the program graphics user interface window are moved according to a preferred embodiment of the invention.

FIG. 5 shows the content of the program graphics user interface window according to a preferred embodiment of the invention.

FIGS. 6A and B are schematic diagrams showing that the program graphics user interface window having a hiding characteristic presented on a title bar of the operating window.

### DETAILED DESCRIPTION OF THE EMBODIMENTS

These and other features, aspects, and advantages of the present invention will become better understood with regard to the following description, appended claims, and accompanying drawings.

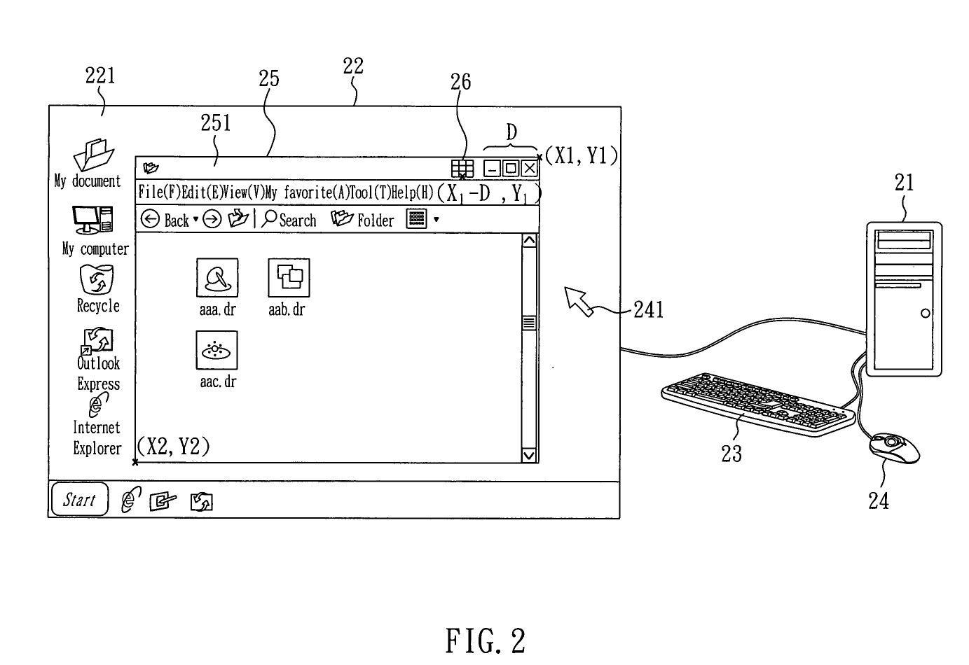

A preferred embodiment of the invention provides a method and computer system capable of presenting program graphics user interface on a title bar of a window. Please refer to a computer system configuration diagram shown in FIG. 2. The computer system according to this embodiment includes a computer host 21, a screen unit 22, a keyboard 23, and a pointer input device 24, wherein the computer host 21 is electrically connected to the screen unit 22, the keyboard 23, and the pointer input device 24 respectively.

In the present embodiment, the computer system is, for example, a desktop computer. In other embodiments, the computer system can also be a bare bone system, a server, or a portable computer, wherein the portable computer includes a laptop, a notebook, a tablet personal computer (PC), a palmtop, and an ultra mobile personal computer (UMPC).

In this embodiment, the screen unit 22 is, for example, a LCD display, the keyboard 23 is, for example, a standard keyboard, and the pointer input device 24 is a mouse. The keyboard 23 is used to input commands and data to the computer host 21 to operate the computer host 21. The pointer input device 24 is provided for the user to operate the Windows operating system conveniently. The screen unit 22 is connected to the computer host 21 to display related information. In this embodiment, the computer host 21 is preferred to be installed with, for example, Vista Windows operating system, which can provide a desktop 221 on the screen unit 22 for the user to control a pointer 241 to operate system via the pointer input device 24. Furthermore, at least one operating window 25 can be started on a desktop 221 to permit a computer program or an operating system to operate the operating window 25 or the content in it.

Although in the preferred embodiment of the invention, the operating system is, for example, Vista, but the operating system could also be Windows XP, Windows 2000, or others in other embodiment. That is, the method capable of presenting program graphics user interface on a title bar of a window according to the invention can also be used in the operating systems besides Vista.

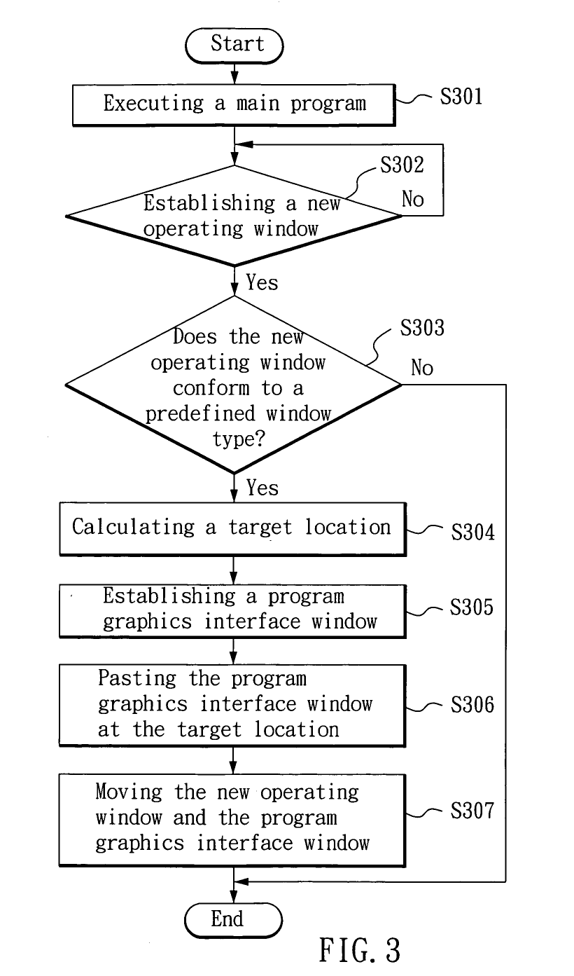

About the description of the preferred embodiment in the invention, please refer to FIG. 2 and FIG. 3, wherein FIG. 3 shows the control flowchart of a method capable of presenting program graphics user interface on a title bar of a window of the preferred embodiment in the invention. First, a main program is executed (step S301), then, whether a new operating window is established is monitored (step S302); if a new operating window is established, in the step S303, whether the new operating window conforms to a predefined window type is further determined; if the new operating window is a dialog window or a specific window such as a media player window, the program graphics user interface is not presented on the title bar of the window, since the sizes of these windows are fixed or the content thereof is unsuitable to be changed. On the contrary, if the new operating window is a standard window capable of changing the size and conforming to a predefined window type, as show in FIG. 2, the operating window 25 is established on the desktop 221 of the screen unit 22. The top of the operating window 25 includes a title bar 251. The small icons, “maximize”, “minimize”, and “close” and so on, which are denoted by “_”, “□”, and “X” and so on, are displayed on the right end of the title bar 251. The small icons occupy a predetermined length D. The operating window 25 has a coordinate location relative to the desktop 221. The coordinate location has a top-right coordinate [X1,Y1] and a bottom-left coordinate [X2,Y2] for defining the size and location of the operating window.

Step S304 is calculating a target location relative to the desktop 221 according to the coordinate location of the operating window 25. The target location is the a top-right coordinate [X1,Y1] minus a predefined predetermined length D, that is, the target location T=[X1−D,Y1]. Therefore, the target location is the position near to the small icons “_”, “□”, and “X” and so on at the title bar 251 on the top of the operating window 25.

Step S305 is establishing a program graphics user interface window 26, the program graphics user interface window 26 is a contracted window.

Step S306 is locating or pasting the program graphics user interface window 26 at the target location [X1−D,Y1] on the desktop 221 without influencing the content of the operating window 25. Therefore, the program graphics user interface window 26 is an individual independent of the operating window 25.

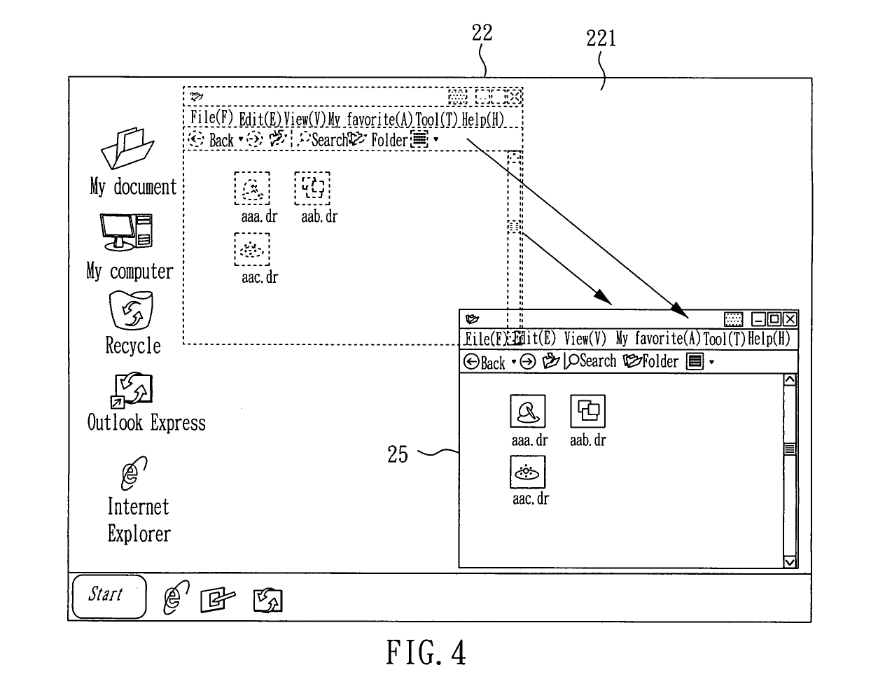

Please refer to FIG. 4, when the operating window 25 is moved to change the coordinate location [X1,Y1] [X2,Y2] of the operating window, the target location [X1−D,Y1] will be changed with it. A changed target location [X1−D,Y1] according to the changed coordinate location [X1,Y1] [X2,Y2] can be calculated, the program graphics user interface window 26 will be moved to locate at the changed target location [X1−D,Y1] (step S307). Although the program graphics user interface window 26 is just located on the operating window 25, it will move with the operating window 25. Therefore, it will achieve an effect of embedding the program graphics user interface window on the window tile bar.

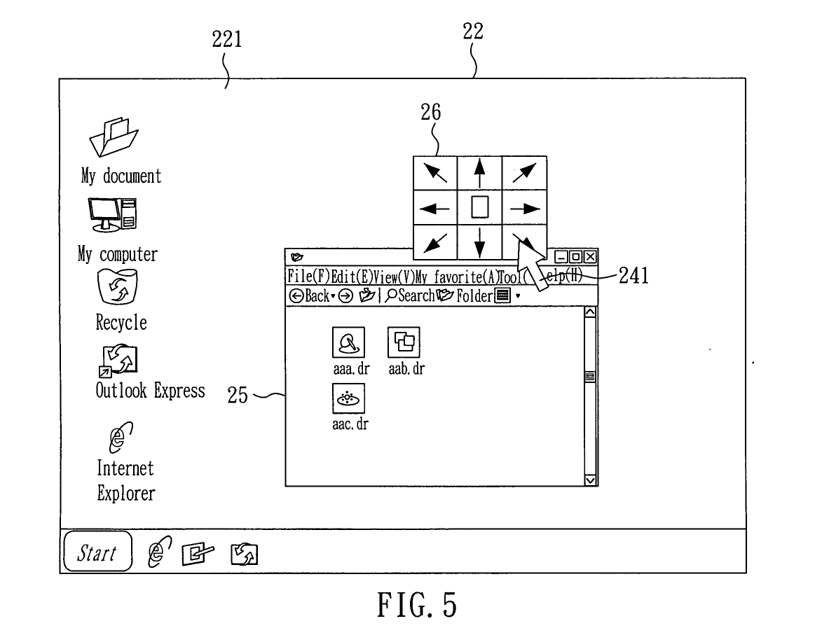

The program graphics user interface window 26 is a contracted window. As shown in FIG. 5, when it is clicked and selected by the pointer 241, it expands the window to display the content. In the embodiment, the program graphics user interface window 26 is used for moving the operating window 25 fast. As show in FIG., the content of the program graphics user interface window 26 includes up, down, left, right, top-left, bottom-left, top-right, bottom-right pointing arrow icons and a centering iron. When an icon is selected, the operating window 25 is adjusted to be a standard size according to the meaning of the icon, and the operating window 25 is moved to the up, down, left, right, top-left, bottom-left, top-right, bottom-right or center of the desktop 221.

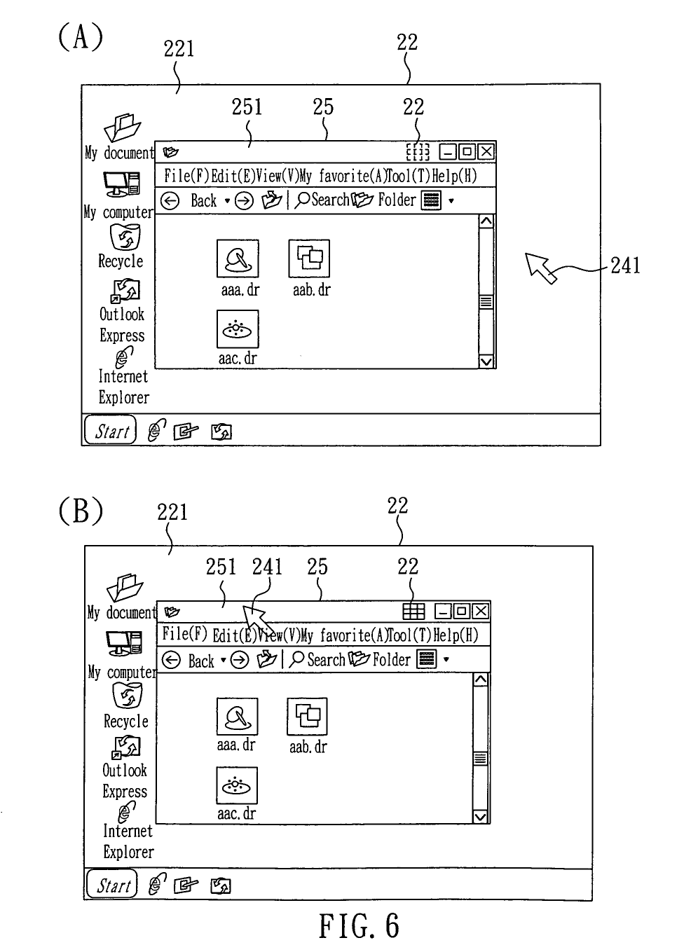

FIG. 6 shows another embodiment of the invention. Wherein the deference between this embodiment and the previous embodiment is that the program graphics user interface window 26 has a hiding characteristic. The program graphics user interface window 26 is hiding at the target location (FIG. 6A). The program graphics user interface window 26 is not displayed at the target location (FIG. 6B) until the pointer 241 points the tile bar 251 on the operating window 25. If the pointer 241 is moved to be away from the tile bar 251 on the operating window 25, the program graphics user interface window 26 is hiding again to keep the operating window 25 be original.

From the above, in the invention, the program graphics user interface window is located on the tile bar on the operating window, and the coordinate location of the program graphics user interface window can be calculated according to the coordinate location of the operating window, so the program graphics user interface window can move with the operating window.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method which is capable of presenting a program graphics user interface on the title bar of a window of a computer, wherein the computer is installed with a Windows operating system which provides a desktop on a screen of the computer, the method comprising the steps of:
(A) determining whether a new operating window is established;
(B) if the new operating window is established, determining whether the new operating window conforms to a predefined window type;
(C) if the new operating window conforms to the predefined window type and comprises a title bar and a coordinate location relative to the desktop, calculating a target location relative to the desktop according to the coordinate location of the operating window;
(D) establishing a program graphics user interface window; and
(E) locating the program graphics user interface window at the target location on the desktop, wherein the program graphics user interface window is an individual which is dependent of the operating window.

2. The method according to claim 1, further comprising the step of:
(F) when the new operating window is moved, and the coordinate location is changed, calculating a changed target location according to the changed coordinate location to locate the program graphics user interface at the changed target location.

3. The method according to claim 1, wherein the Windows operating system is the Vista operating system.

4. The method according to claim 1, wherein in the step (C), the coordinate location comprises an top-right coordinate location and a bottom-left coordinate location to define the size and location of the operating window.

5. The method according to claim 4, wherein the target location is the top-right coordinate minus a predetermined length.

6. The method according to claim 1, wherein in the step (C), the target location is at the title bar on the upside of the operating window.

7. The method according to claim 6, wherein in the step (D), the program graphics user interface window has a hiding characteristic and hides on the target location, and the program graphics user interface window is not displayed at the target location until a pointer points towards the title bar of the operating window.

8. The method according to claim 1, wherein in the step (D), the established program graphics user interface window is a contracted window.

9. The method according to claim 8, wherein when the contracted window is pointed and selected by the pointer, the window is expanded to display the content.

10. The method according to claim 9, wherein the content of the program graphics user interface window comprises a plurality of pointing arrows, and when one of the pointing arrows is selected, the operating window is moved according to the direction pointed by the pointing arrow.

11. A computer system capable of presenting a program graphics user interface on a title bar of a window, comprising:
a pointer input device;
a computer host for executing a Windows operating system; and
a screen unit on which the Windows operating system provides a desktop for using the pointer input device to operate by a pointer, wherein an operating window which conforms to a predefined window type is established on the desktop, and the operating window comprises a title bar and a coordinate location relative to the desktop;
wherein a program graphics user interface window is established and located on the desktop at a target location which is calculated according to the coordinate location of the operating window, and the program graphics user interface window is an individual which is independent of the operating window.

12. The computer system according to claim 11, wherein when the operating window is moved, and the coordinate location of the operating window is changed, a changed target location is calculated according to the changed coordinate location, and the program graphics user interface window is moved and located at the changed target location.

13. The computer system according to claim 12, wherein the Windows operating system executed by the computer host is the Vista operating system.

14. The computer system according to claim 11, wherein the coordinate location comprises a top-right coordinate and a bottom-left coordinate for defining the size of the operating window.

15. The computer system according to claim 14, wherein the target location is the top-right coordinate minus a predefined predetermined length.

16. The computer system according to claim 11, wherein the target location is on the title bar on the top of the operating window.

17. The computer system according to claim 16, wherein the program graphics user interface window has a hiding characteristic and hides at the target location, and the program graphics user interface window is not displayed at the target location until a pointer points the tile bar of the operating window.

18. The computer system according to claim 11, wherein the established program graphics user interface window is a contract window.

19. The computer system according to claim 18, wherein when the contract window is pointed and selected by the pointer, the window is expanded to display the content.

20. The computer system according to claim 19, wherein the content of the program graphics user interface window comprises a plurality of pointing arrows, and when one of the pointing arrows is selected, the operating window is moved according to the direction pointed by the pointing arrow.
